(19) United States
(12) Patent Application Publication
(10) Pub. No.: US 2025/0385438 A1
(43) Pub. Date: Dec. 18, 2025

(54) ELECTRONIC DEVICE

(71) Applicant: Advanced Semiconductor Engineering, Inc., Kaohsiung (TW)

(72) Inventors: Po-An LIN, Kaohsiung (TW); Yen-Ting WANG, Kaohsiung (TW)

(73) Assignee: Advanced Semiconductor Engineering, Inc., Kaohsiung (TW)

(21) Appl. No.: 18/746,028

(22) Filed: Jun. 17, 2024

(51) Int. Cl. H01Q 19/00; H01Q 1/22; H01Q 19/06

(52) U.S. Cl. CPC H01Q 19/00; H01Q 1/22; H01Q 19/06

(57) ABSTRACT

An electronic device is provided. The electronic device includes a directing structure and a first antenna. The directing structure includes a central region and a peripheral region. An equivalent dielectric constant of the central region is greater than that of the peripheral region. The first antenna is configured to transceive first radio-frequency (RF) signals through the directing structure.

### BACKGROUND

### 1. Field of the Disclosure

The present disclosure generally relates to an electronic device, in particular to an electronic device including a directing structure.

### 2. Description of the Related Art

In order to reduce the size of electronic devices and achieve higher integration density, various packaging solutions have been developed and implemented, including antenna in package (AiP), antenna on package (AoP), and directing structures. The directing structure is designed to converge signals, such as electromagnetic waves. However, traditional directing structures have larger dimensions, which increases the overall size of electronic devices. To improve the performance of electronic devices while maintaining a smaller size, it is essential to develop new technologies or enhance existing ones.

### SUMMARY

In some embodiments, an electronic device includes a directing structure and a first antenna. The directing structure includes a central region and a peripheral region. An equivalent dielectric constant of the central region is greater than that of the peripheral region. The first antenna is configured to transceive first radio-frequency (RF) signals through the directing structure.

In some embodiments, an electronic device includes a directing structure and a first antenna. The first antenna is configured to transceive first radio-frequency (RF) signals. The directing structure is over the first antenna and includes a first medium with a density varying along a horizontal direction. The directing structure is configured to converge the first RF signals.

In some embodiments, an electronic device includes a directing structure and a first antenna. The first antenna is configured to transceive first radio-frequency (RF) signals. The directing structure defines a plurality of through vias configured to converge the first RF signals.

### BRIEF DESCRIPTION OF THE DRAWINGS

Aspects of some embodiments of the present disclosure are readily understood from the following detailed description when read with the accompanying figures. It is noted that various structures may not be drawn to scale, and dimensions of the various structures may be arbitrarily increased or reduced for clarity of discussion.

FIG. 1A is a cross-sectional view of an electronic device, in accordance with an embodiment of the present disclosure.

FIG. 1B is a top view of the electronic device as shown in FIG. 1A, in accordance with an embodiment of the present disclosure.

FIG. 2 is a schematic view of a directing structure, in accordance with an embodiment of the present disclosure.

FIG. 3A is a cross-sectional view of an electronic device, in accordance with an embodiment of the present disclosure.

FIG. 3B is a top view of the electronic device as shown in FIG. 3A, in accordance with an embodiment of the present disclosure.

FIG. 4 is a top view of an electronic device, in accordance with an embodiment of the present disclosure.

FIG. 5 is a top view of an electronic device, in accordance with an embodiment of the present disclosure.

FIG. 6 is a top view of an electronic device, in accordance with an embodiment of the present disclosure.

FIG. 7 is a top view of an electronic device, in accordance with an embodiment of the present disclosure.

### DETAILED DESCRIPTION

Common reference numerals are used throughout the drawings and the detailed description to indicate the same or similar components. Embodiments of the present disclosure will be readily understood from the following detailed description taken in conjunction with the accompanying drawings.

The following disclosure provides for many different embodiments, or examples, for implementing different features of the provided subject matter. Specific examples of components and arrangements are described below to explain certain aspects of the present disclosure. These are, of course, merely examples and are not intended to be limiting. For example, the formation of a first feature over or on a second feature in the description that follows may include embodiments in which the first and second features are formed or disposed in direct contact, and may also include embodiments in which additional features may be formed or disposed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

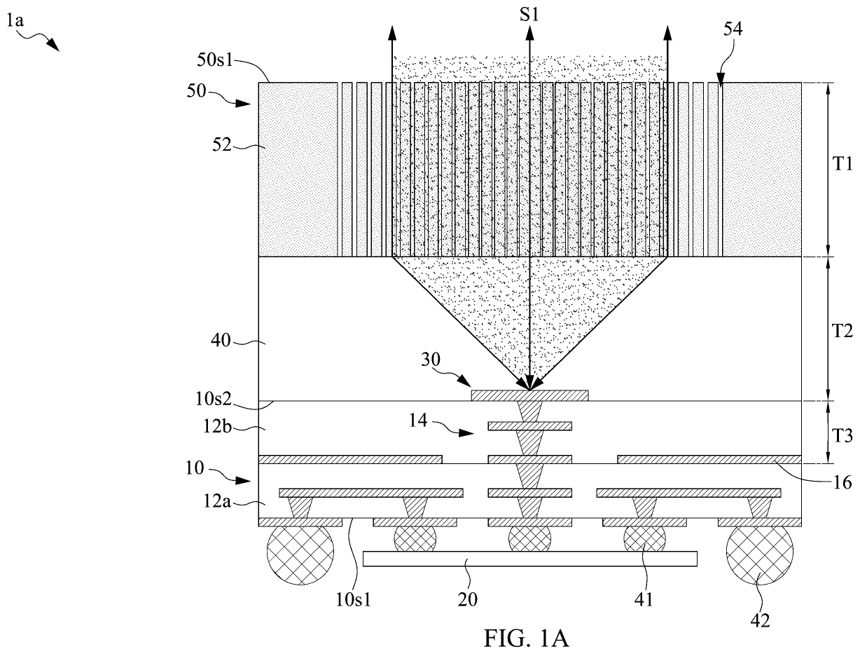

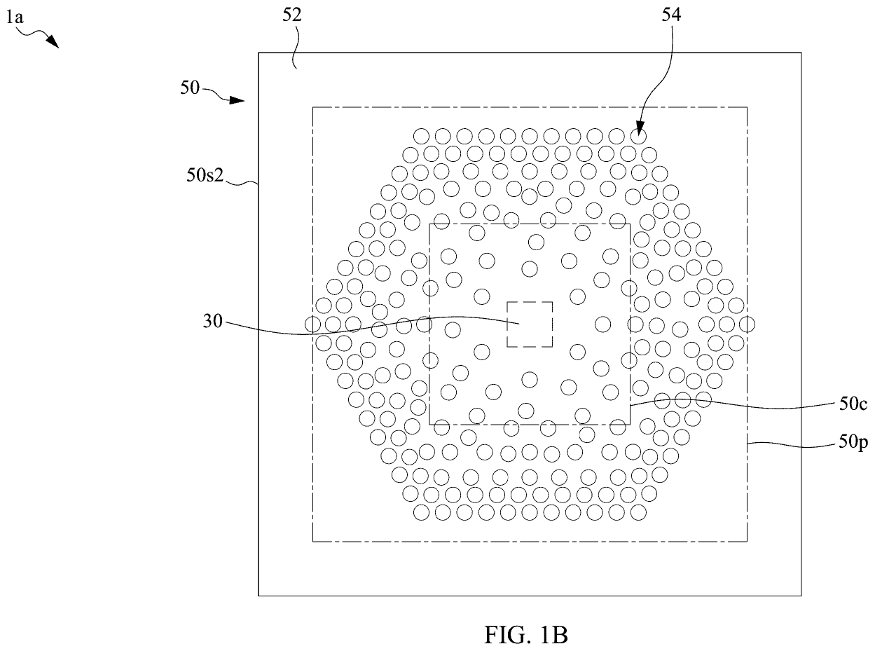

FIG. 1A is a cross-sectional view of an electronic device 1a, in accordance with an embodiment of the present disclosure. In some embodiments, the electronic device 1a may be applicable to, for example, a wireless device, such as a user equipment (UE), a mobile station, a mobile device, an apparatus communicating with the Internet of Things (IoT), etc. In some embodiments, the electronic device 1a may be or include a portable device. In some embodiments, the electronic device 1a may support fifth generation (5G) communications, such as Sub-6 GHz frequency bandwidths and/or millimeter (mm) wave frequency bandwidths. For example, the electronic device 1a may incorporate both Sub-6 GHz devices and mm wave devices. In some embodiments, the electronic device 1a may support beyond-5G or 6G communications, such as terahertz (THz) frequency. The electronic device 1a may be configured to radiate, receive, and/or transceive electromagnetic signals, such as radio frequency (RF) signals. For example, the electronic device 1a may be configured to operate in a frequency between about 1 GHz and about 10 THz, such as 1 GHZ, 5 GHZ, 10 GHZ, 20 GHZ, 30 GHZ, 40 GHZ, 50 GHz, 100 GHz, 300 GHz, 1 THz, 5 THz, or 10 THz.

In some embodiments, the electronic device 1a may include a circuit structure 10, an electronic component 20, an antenna 30, a dielectric layer 40, and a directing structure 50.

In some embodiments, the circuit structure 10 may include a plurality of dielectric layers with different dimensions (e.g., thickness) and a plurality of conductive elements with different dimensions. The circuit structure 10 may be or include, for example, a substrate. In some embodiments, the circuit structure 10 may include, for example, a printed circuit board (PCB), such as a paper-based copper foil laminate, a composite copper foil laminate, or a polymer-impregnated glass-fiber-based copper foil laminate. In some embodiments, the circuit structure 10 may include a dielectric layer 12a and a dielectric layer 12b over the dielectric layer 12a. The dielectric layer 12a and dielectric layer 12b may include polypropylene, polyimide, or other suitable materials. Each of the dielectric layer 12a and dielectric layer 12b may include one or more layers. In some embodiments, the dielectric layer 12a and dielectric layer 12b may have the same or different dielectric constants.

The circuit structure 10 may include a redistribution structure 14. The redistribution structure 14 may be disposed within, abutting, and/or on the dielectric layer 12a and dielectric layer 12b. The redistribution structure 14 may include a conductive pad(s), trace(s), via(s), layer(s), or other interconnection(s). In some embodiments, the redistribution structure 14 may include a feeding element configured to provide the antenna 30 with a signal (e.g., a feed signal) from the electronic component 20. In some embodiments, the redistribution structure 14 may include a grounding element electrically connected to ground. The redistribution structure 14 may include a conductive material(s), such as copper, gold, silver, aluminum, titanium, tantalum, or the like. In some embodiments, the circuit structure 10 may include a grounding layer 16. The grounding layer 16 may be disposed on or over the dielectric layer 12a. The grounding layer 16 may be electrically connected to the ground. In some embodiments, the grounding layer 16 may function as a reference ground.

The circuit structure 10 may have a surface 10s1 (or a lower surface) and a surface 10s2 (or an upper surface) opposite to the surface 10s1. In some embodiments, the bottom of the dielectric layer 12a may function as the surface 10s1. In some embodiments, the top of the dielectric layer 12b may function as the surface 10s2.

In some embodiments, the electronic component 20 may be disposed on or under the surface 10s1 of the circuit structure 10. The electronic component 20 may be electrically connected to one or more other electrical components (if any) and to the circuit structure 10 (e.g., to the interconnection(s)), and the electrical connection may be attained by way of flip-chip, wire-bond techniques, metal to metal bonding (such as Cu to Cu bonding), or hybrid bonding. The electronic component 20 may be a chip or a die including a semiconductor substrate, one or more integrated circuit (IC) devices and one or more overlying interconnection structures therein. The IC devices may include active devices such as transistors and/or passive devices such as resistors, capacitors, inductors, or a combination thereof. For example, the electronic component 20 may include a system on chip (SoC). For example, the electronic component 20 may include a radio frequency integrated circuit (RFIC), an application-specific IC (ASIC), a central processing unit (CPU), a microprocessor unit (MPU), a graphics processing unit (GPU), a microcontroller unit (MCU), a field-programmable gate array (FPGA), or another type of IC. In some embodiments, the electronic component 20 may be configured to provide the redistribution structure 14 with a signal (e.g., a feed signal). In some embodiments, the electronic component 20 may be configured to provide the antenna 30 with a signal (e.g., a feed signal) through the redistribution structure 14 of the circuit structure 10.

The electronic component 20 may be electrically connected to the circuit structure 10 through electrical connections 41. The electrical connections 41 may be disposed on or under the surface 10s1 of the circuit structure 10. In some arrangements, the electrical connections 41 may include a controlled collapse chip connection bump, a ball grid array, or a land grid array. The electrical connections 41 may include, for example, a solder material, such as alloys of gold and tin solder or alloys of silver and tin solder.

The electronic device 1a may further include electrical connections 42. The electrical connections 42 may be disposed on or under the surface 10s1 of the circuit structure 10. The electrical connections 42 may be configured to be connected to an external device (not shown). In some arrangements, the electrical connections 42 may include a controlled collapse chip connection bump, a ball grid array, or a land grid array. The electrical connections 42 may include, for example, a solder material, such as alloys of gold and tin solder or alloys of silver and tin solder. The electrical connections 42 may have a dimension (e.g., size or diameter) greater than that of the electrical connections 41. In some embodiments, the electrical connections 42 may surround the electronic component 20.

The antenna 30 may be disposed on or over the surface 10s2 of the circuit structure 10. In some embodiments, the antenna 30 may be configured to radiate and/or receive electromagnetic signals, such as radio frequency (RF) signals. For example, the antenna 30 may be configured to operate in a frequency between about 10 GHz and about 500 GHz, such as 10 GHz, 20 GHz, 30 GHz, 40 GHz, 50 GHZ, 100 GHZ, 300 GHZ, or 500 GHZ. In some embodiments, the antenna 30 may support fifth generation (5G) communications, such as Sub-THz frequency bandwidths and/or millimeter (mm) wave frequency bandwidths. In some embodiments, the antenna 30 may include a patch antenna. In some embodiments, the patch antenna may include or consist of one or more flat, rectangular or circular patches of metal.

In some embodiments, the dielectric layer 40 (or medium) may be disposed on or over the surface 10s2 of the circuit structure 10. In some embodiments, the dielectric layer 40 may cover the antenna 30. In some embodiments, the dielectric layer 40 may be in contact with the circuit structure 10. In some embodiments, the dielectric layer 40 may be configured to support the directing structure 50. In some embodiments, the dielectric layer 40 may include a medium configured to allow RF signals, emitted from or transmitted to the antenna 30, to pass through. In some embodiments, the dielectric layer 40 may include polyimide, polybenzoxazole, benzocyclobuten, or other suitable materials. In other embodiments, the dielectric layer 40 may be a hollow frame composed of glass, polymer, metal, or other suitable materials, with the space inside the frame filled with air.

In some embodiments, the directing structure 50 may be disposed on or over the dielectric layer 40. In some embodiments, the directing structure 50 may be spaced apart from the circuit structure 10 by the dielectric layer 40. In some embodiments, the directing structure 50 may be spaced apart from the antenna 30. In some embodiments, the directing structure 50 may be configured to converge, guide, and/or direct signals (e.g., RF signals). In some embodiments, the directing structure 50 may make a signal (e.g., RF signal) converge in a desired area (or point) or a desired direction. As shown in FIG. 1A, the antenna 30 may be configured to transceive a signal S1 (e.g., RF signals) through the directing structure 50. When the signal S1 is emitted from the antenna 30 towards the directing structure 50, it may initially be a divergent sphere wave. However, after passing through or during its passage through the directing structure 50, the signal S1 is transformed into a plane wave. Similarly, when a plane wave is transmitted to the antenna 30 through the directing structure 50, it is transformed into a convergent spherical wave as it passes through or after passing through the directing structure 50, and is then received by the antenna 30. The directing structure 50 may have a surface 50s1 (or an upper surface) and a surface 50s2 (or a lateral surface or a side). In some embodiments, the surface 50s1 may be a substantially flat surface.

In some embodiments, the directing structure 50 may include a gradient flat lens. In some embodiments, the directing structure 50 may include a medium 52 and a medium 54. In some embodiments, the medium 52 may include a lens or other suitable materials.

In some embodiments, the medium 54 may include a plurality of through vias filled with a material (or air) having a dielectric constant less than that of the medium 52. In some embodiments, a portion of the medium 52 may be removed, by a removal technique (e.g., etching, laser ablation, or other suitable techniques), to form medium 54. In some embodiments, the medium 54 may penetrate the medium 52. In some embodiments, the medium 54 may fully penetrate the medium 52. In some embodiments, the sidewall of the medium 54 (or the sidewall of the medium 52) may be substantially orthogonal to the lower surface and/or the upper surface of the medium 52. In some embodiments, the sidewall of the medium 54 (or the sidewall of the medium 52) may be slanted with respect to the lower surface and/or the upper surface of the medium 52. In some embodiments, the sidewall of the medium 54 (or the sidewall of the medium 52) may be tapered toward the lower surface of the medium 52. In some embodiments, the medium 54 may be distributed non-uniformly. As a result, the directing structure 50 may have a non-uniform dielectric constant, causing the signals (e.g., signal S1) to converge when passing through the directing structure 50. In some embodiments, the diameter of the openings of the medium 54 may depend on the wavelength (or frequency) of the signal S1. In some embodiments, the dielectric constant of the directing structure 50 may be greater than that of the dielectric layer 40. In some embodiments, the dielectric constant of the medium 52 may be greater than that of the dielectric layer 40. In some embodiments, the diameters of the openings of each of the medium 54 may be substantially the same. In some embodiments, the diameters of the openings of each of the medium 54 may be different along a horizontal direction. For example, the opening of the medium 54 may have a relatively small aperture (or diameter) at a central region, and the opening of the medium 54 may have a relatively large aperture (or diameter) at a peripheral region.

Please refer to FIG. 1B, which illustrates a top view of the electronic device 1a. In some embodiments, each of the through vias of the medium 54 may have a circular profile, an oval profile, an elliptical profile, or other suitable profiles. In some embodiments, the through vias of the medium 54 may be filled with a material or air with a dielectric constant less than that of the medium 52. In some embodiments, the medium 54 may have a lower density at a central region 50c and a higher density at a peripheral region 50p. As used herein, the term “central region” is closer to the center (e.g., geometry center) of the directing structure 50 than the “peripheral region” is; the term “peripheral region” is closer to the surface 50s2 (or side or lateral surface) of the directing structure 50 than the “central region” is.

Although FIG. 1B illustrates that the central region 50c and the peripheral region 50p have a rectangular profile, it should be noted that the central region 50c and the peripheral region 50p can be defined with any profiles (e.g., a circular profile) and dimensions.

The density of the medium 54 may indicate the quantity of the medium 54 per unit area of the directing structure 50, or the surface area (e.g., upper surface) of the medium 54 per unit area of the directing structure 50, or the volume of the medium 54 per unit volume of the directing structure 50. When a region has the medium 54 with a lower density, said region has the medium 52 with a higher density. For example, the medium 52 may have a greater density at a central region 50c and a lower density at a peripheral region 50p. The medium 54 may have a lower density at a central region 50c and a greater density at a peripheral region 50p.

In some embodiments, when a region has a greater density of the medium 52, said region has a relatively large equivalent dielectric constant. In some embodiments, when a region has a greater density of the medium 54, said region has a relatively small equivalent dielectric constant. In some embodiments, the central region 50c of the directing structure 50 may have an equivalent dielectric constant greater than that of the peripheral region 50p of the directing structure 50. In some embodiments, each of through vias of the medium 54 may be arranged within an imaginary hexagonal profile(s). In other embodiments, the medium 54 may be arranged within an imaginary circular profile(s) or other profiles.

Please refer back to FIG. 1A, the density of the medium 54 (or medium 52) may vary along a horizontal direction, which is substantially orthogonal to the normal direction of the surface 10s2 of the circuit structure 10. Variations in the density of the medium 54 (or medium 52) can result in the directing structure 50 having different permittivity in various regions (e.g., central region and peripheral region), causing a signal (e.g., electromagnetic wave) passing through the directing structure 50 to experience different phase delays. For example, when a divergent spherical wave passes through the directing structure 50, it will be converged and transformed into a plane wave.

The directing structure 50 may have a thickness T1. The dielectric layer 40 may have a thickness T2. The dielectric layer 12b may have a thickness T3. In some embodiments, the thickness T1 may be greater than the thickness T2. In some embodiments, the thickness T2 may be greater than the thickness T3. In some embodiments, the thickness T1 may depend on the wavelength (or frequency) of the signal (e.g., signal S1). In some embodiments, the thickness T2 may depend on the wavelength (or frequency) of the signal (e.g., signal S1). In some embodiments, the thickness T3 may depend on the wavelength (or frequency) of the signal (e.g., signal S1). For example, when the antenna 30 is operated at a frequency of 100 GHz, the thickness T1 may range between 3.5 mm and about 5 mm, the thickness T2 may range between 2.2 mm and about 3.5 mm, and the thickness T3 may range between 0.05 mm and about 1 mm. When the antenna 30 is operated at a frequency of 300 GHz, the thickness T1 may range between 0.7 mm and about 2 mm, the thickness T2 may range between 0.5 mm and about 1.3 mm, and the thickness T3 may range between 0.01 mm and about 0.1 mm. In some embodiments, the thickness T1 is substantially uniform. For example, the upper surface of the medium 52 (or medium 54) is substantially parallel to the lower surface of the medium 52 (or medium 54). In some embodiments, the thickness T1 is substantially uniform at the central region (e.g., the central region 50c as shown in FIG. 1B) and at the peripheral region (e.g., the peripheral 50p as shown in FIG. 1B). For example, the top surface of the medium 52 may have a substantially uniform elevation with respect to the surface 10s2 of the circuit structure 10. In some embodiments, the thickness of the medium 52 is substantially uniform at the central region (e.g., the central region 50c as shown in FIG. 1B) and at the peripheral region (e.g., the peripheral region 50p as shown in FIG. 1B).

In some embodiments, the thickness T2 may be substantially equal to a focal length, which is a distance between the directing structure 50 and the focal point of the signal S1. In some embodiments, the antenna 30 may be located at the focal point (or near the focal point) of the signal S1. In some embodiments, the focal length may be defined as a distance between the directing structure 50 and the antenna 30 (or the surface 10s2 of the circuit structure 10) or a distance substantially equal to the thickness T2. In some embodiments, the thickness T2 may be substantially uniform at the central region (e.g., the central region 50c as shown in FIG. 1B) and at the peripheral region (e.g., the peripheral region 50p as shown in FIG. 1B).

In this embodiment, the directing structure 50 has a substantial flat surface (e.g., flat upper surface). In comparison with a conventional directing structure which has a convex profile, the directing structure 50 may have a relatively small thickness. Therefore, the dimension (e.g., thickness) of the electronic device 1a may be reduced. Further, the density variation of the medium 54 can be configured to focus the signal(s), thereby improving the performance of the electronic device 1a.

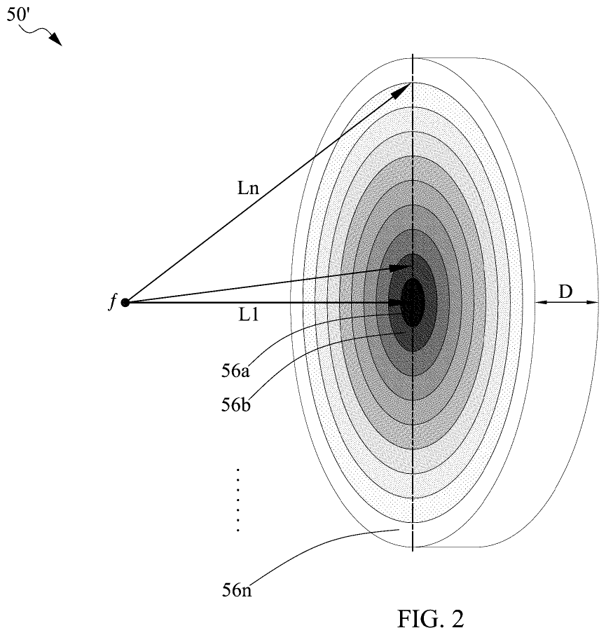

FIG. 2 is a schematic view of a directing structure 50′, in accordance with an embodiment of the present disclosure. In some embodiments, the directing structure 50′ may be applicable to the electronic device 1a or other electronic devices of the present disclosure.

In some embodiments, the directing structure 50′ may have multiple regions, such as regions 56a, 56b, and 56n. The region 56a is closer to the central (e.g., geometric center) of the directing structure 50′ than the region 56b is. The region 56b is closer to the central of the directing structure 50′ than the region 56n is. For example, the region 56a can be referred to as a central region, while the region 56b can be referred to as a peripheral region, relatively to the region 56a, in some embodiments; the region 56b can be referred to as a central region, while the region 56n can be referred to as a peripheral region, relatively to the region 56b, in some embodiments.

Each of the regions 56a, 56b, and 56n may have different relative permittivities. In some embodiments, the permittivity of the region 56a may be greater than that of the region 56b. In some embodiments, the permittivity of the region 56b may be greater than that of the region 56n. In some embodiments, the permittivity of the region 56n may be satisfied with the following equation: εₙ=((L1−Ln+(ε₁)^{0.5}×D)/D)², wherein L1 is the distance between the focal point F and the region 56a, Ln is the distance between the focal point F and the region 56n, ε₁ is the permittivity of the region 56a, D is the thickness of the directing structure 50′. The density of the medium 54 depicted in FIG. 1B can impact permittivity. Therefore, a particular configuration of the medium 54 could be devised to create a signal with the necessary phase delay in order to facilitate the conversion between a plane wave and a spherical wave. The density of the medium 54 (shown in FIG. 1B) in the region 56a may be less than that in the region 56b, and the density of the medium 54 (shown in FIG. 1B) in the region 56b may be less than that in the region 56n.

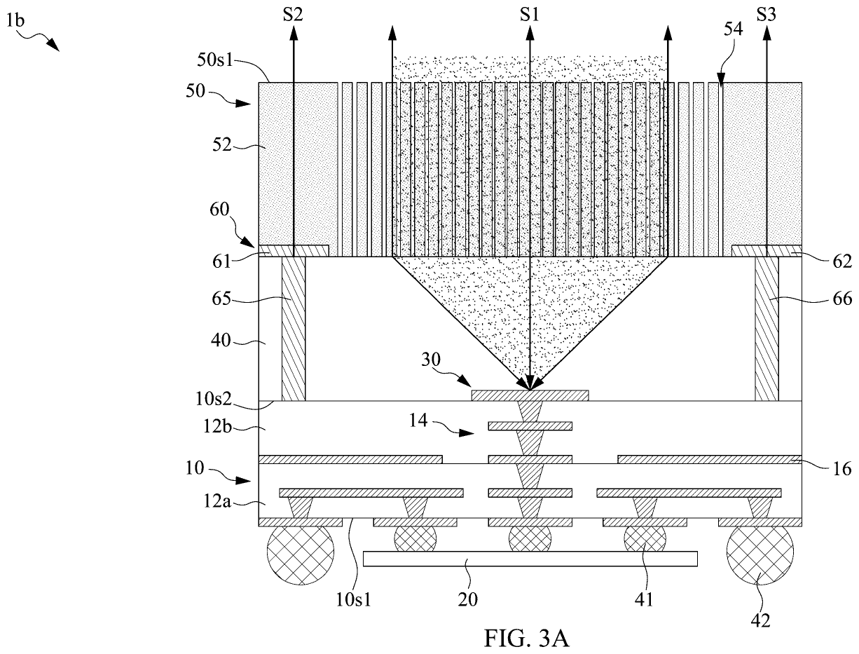

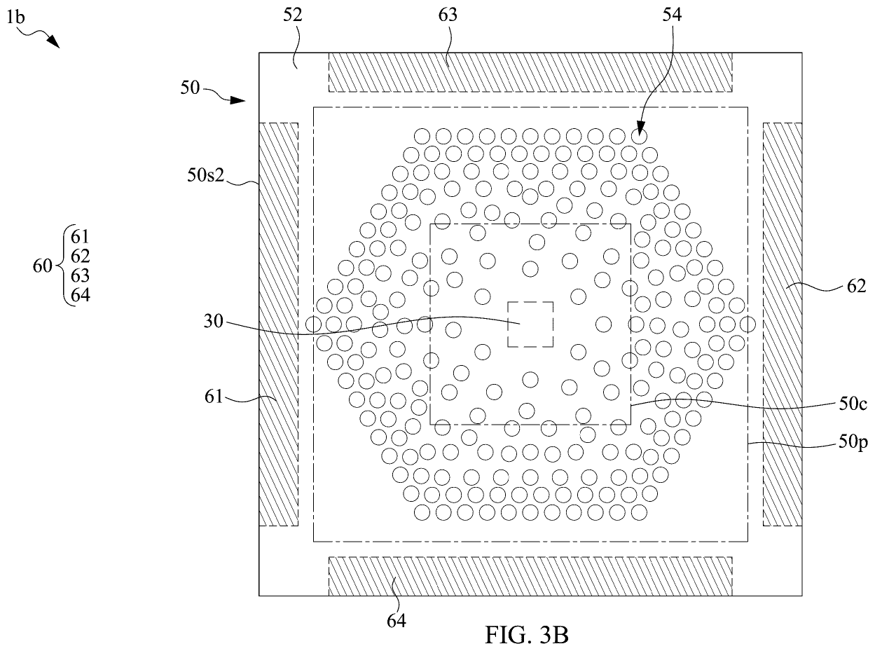

FIG. 3A and FIG. 3B illustrate an electronic device 1b, in accordance with an embodiment of the present disclosure. The electronic device 1b is similar to the electronic device 1a, and the differences therebetween are described below.

In some embodiments, the electronic device 1b may further include an antenna 60. In some embodiments, the antenna 60 may be configured to radiate and/or receive electromagnetic signals, such as RF signals. For example, the antenna 60 may be configured to operate in a frequency between about 1 GHz and about 50 GHz, such as 1 GHz, 2 GHZ, 3 GHZ, 4 GHZ, 5 GHZ, 10 GHZ, 30 GHZ, or 50 GHZ. In some embodiments, the antenna 60 may support sub-six generation (6G) communications. In some embodiments, the operation frequency of the antenna 60 may be less than that of the antenna 30. For example, the antenna 60 may be operated at a frequency of 3 GHZ, and antenna 30 may be operated at a frequency of 30 GHZ; the antenna 60 may be operated at a frequency of 6 GHZ, and antenna 30 may be operated at a frequency of 60 GHZ; the antenna 60 may be operated at a frequency of 30 GHZ, and antenna 300 may be operated at a frequency of 30 GHZ. In some embodiments, the antenna 60 may include a dipole antenna.

As shown in FIG. 3B, in some embodiments, the antenna 60 may include segments 61, 62, 63, and 64. Each of the segments 61 to 64 may include a radiating element (or patch) over or abutting the upper surface of the dielectric layer 40. In some embodiments, the radiating element may be in contact with and embedded within the medium 52. In some embodiments, each of the segments 61 to 64 may be free from vertically overlapping the medium 54. In some embodiments, each of the segments 61 to 64 may be located at a peripheral region of the directing structure 50 from a top view. In some embodiments, each of the segments 61 to 64 may be closer to the surface 50s2 of the directing structure 50 than the medium 54 is in a top view. In some embodiments, each of the segments 61 to 64 may be closer to the surface 50s2 of the directing structure 50 than the antenna 30 is in a top view. In some embodiments, each of the segments 61 to 64 may be free from vertically overlapping the antenna 30. In some embodiments, the segments 61 to 64 may be configured to emit or receive a signal with the same frequency (or frequency bandwidth) or different frequencies (or frequency bandwidth). For example, the segment 61 may be configured to transceive a signal S2, and the segment 62 may be configured to transceive a signal S3 with a frequency different from that of the signal S2. In some embodiments, the signals S2 and S3 may not pass through the medium 54. In some embodiments, the signals S2 and S3 may be free of phase delays caused by the medium 54. The segments 61 to 64 may surround the antenna 30 in a top view.

Please refer back to FIG. 3A, the antenna 60 may include pillars 65 and 66. Each of the pillars 65 and 66 may penetrate the dielectric layer 40. The pillar 65 may support the segment 61. The pillar 66 may support the segment 62. Although not shown in FIG. 3A, the antenna 60 may include pillars supporting the segments 63 and 64. Each of the pillars (e.g., pillars 65 and 66) may function as a feeding element configured to transmit a feeding signal to the radiating element (e.g., segments 61 to 64). In some embodiments, each of the pillars 65 and 66 may support the directing structure 50 (or medium 52). Each of the pillars (e.g., pillars 65 and 66) may surround the antenna 30 in a top view. Each of the pillars (e.g., pillars 65 and 66) be free from vertically overlapping the medium 54.

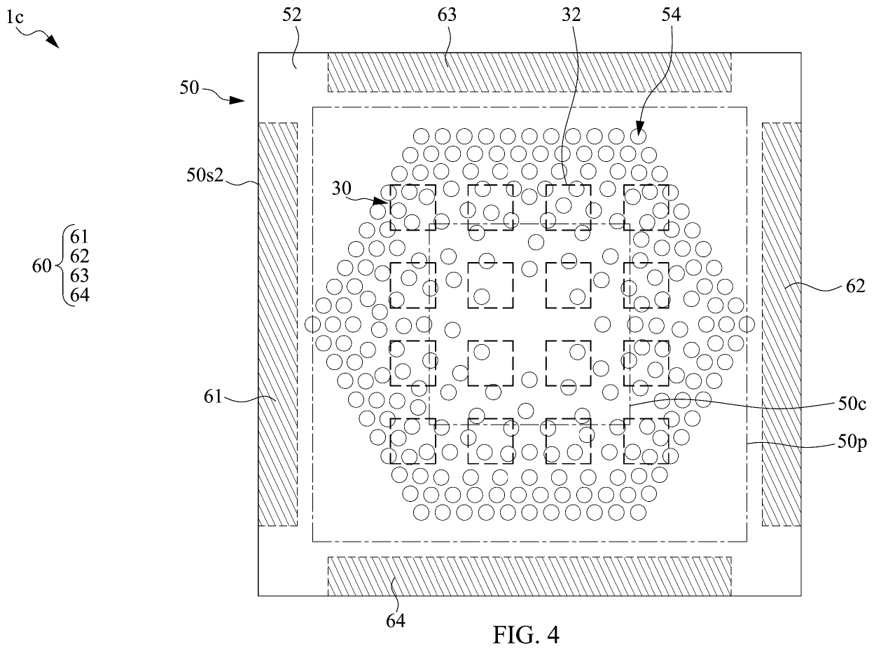

FIG. 4 is a top view of an electronic device 1c, in accordance with an embodiment of the present disclosure. The electronic device 1c is similar to the electronic device 1b, and the differences therebetween are described below.

In some embodiments, the antenna 30 may have a plurality of segments 32. Each of the segments 32 may be configured to emit or receive an RF signal(s). In some embodiments, the segments 32 may be arranged as an M×N array. For example, the segments 32 may be arranged as a 4×4 array as shown in FIG. 4. In other embodiments, the segments 32 may be arranged as a 1×2 array, 2×2 array, or other suitable arrangements. In some embodiments, some of the segments 32 may be disposed under the central region 50c of the directing structure 50. In some embodiments, some of the segments 32 may be disposed under the peripheral region 50p of the directing structure 50. In some embodiments, the projection on to the directing structure 50 of one of the segments 32 (e.g., the segment 32 at the peripheral region) corresponds to a region with a greater density of the medium 54, and the projection on to the directing structure 50 of another segment 32 (e.g., the segment 32 at the central region) corresponds to a region with a smaller density of the medium 54. For example, the projection on to the directing structure 50 of one of the segments 32 (e.g., the segment 32 at the peripheral region) corresponds to a region with a smaller equivalent dielectric constant, and the projection on to the directing structure 50 of another segment 32 (e.g., the segment 32 at the central region) corresponds to a region with a greater equivalent dielectric constant. The segments 32 may be equally spaced from the top view. For example, the segments 32 may be arranged by an equal spacing or interval. However, in some embodiments, the segments 32 may be arranged randomly.

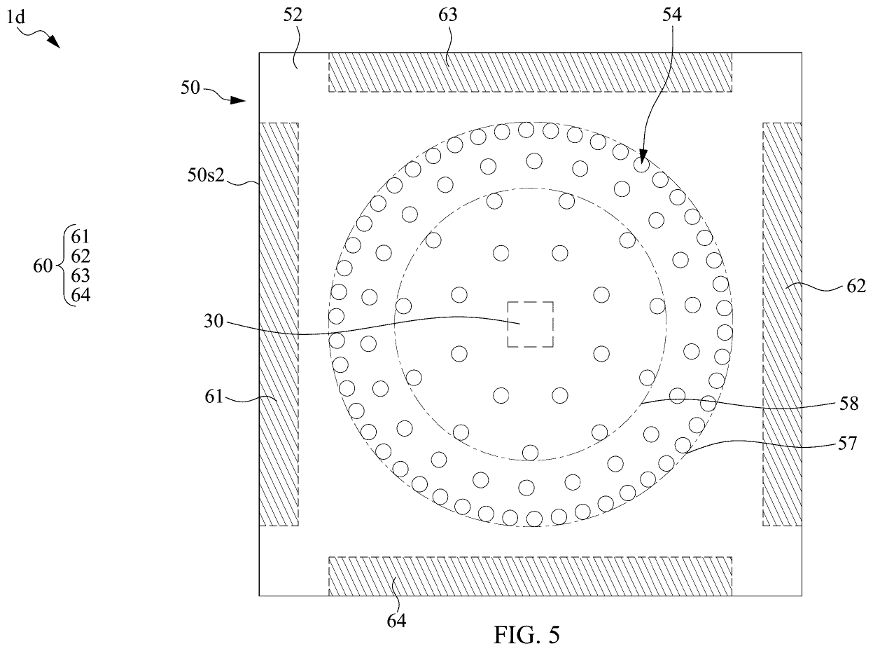

FIG. 5 is a top view of an electronic device 1d, in accordance with an embodiment of the present disclosure. The electronic device 1d is similar to the electronic device 1b, and the differences therebetween are described below.

In some embodiments, the medium 54 may be arranged within an imaginary circular profile(s). For example, the through vias of the medium 54 may be arranged within or on multiple circular profiles. For example, the through vias of the medium 54 may include an outer circle 57 and an inner circle 58. In some embodiments, the through vias of the medium 54 at the outer circle 57 have a greater density than the through vias of the medium 54 at the inner circle 58 have. Thus, the directing structure 50 may have a greater equivalent dielectric constant at the central region (or inner circle region) and a smaller equivalent dielectric constant at the peripheral region (or outer circle region).

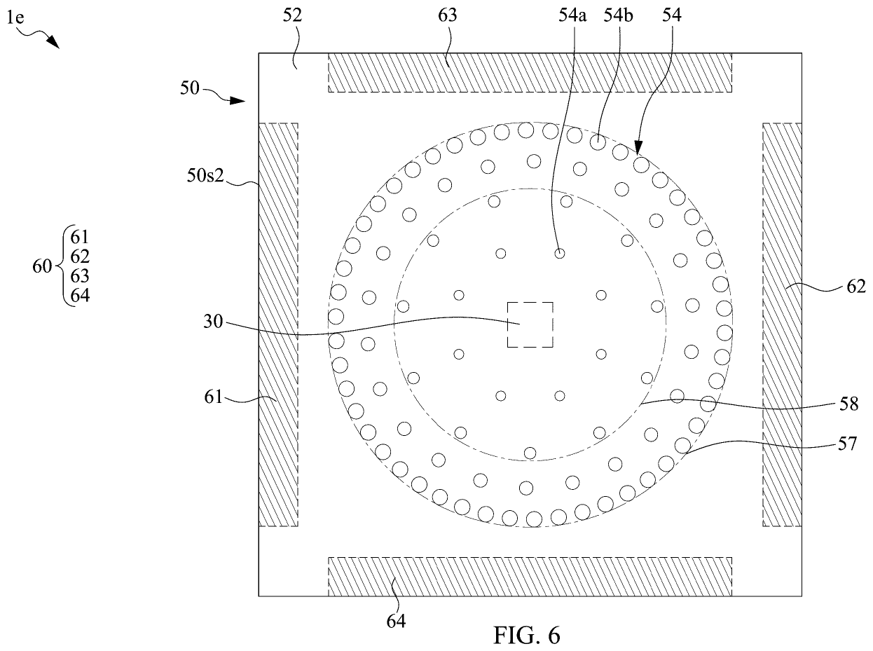

FIG. 6 is a top view of an electronic device 1e, in accordance with an embodiment of the present disclosure. The electronic device 1e is similar to the electronic device 1e, and the differences therebetween are described below.

In some embodiments, the medium 54 may have different dimensions (e.g., surface area or diameter). In some embodiments, the through via 54b at the outer circle 57 has a greater dimension than the through via 54a at the inner circle 58 has. In this embodiment, the medium 54 within the central region has a smaller dimension than the medium 54 within the peripheral region has. Thus, the directing structure 50 may have a greater equivalent dielectric constant at the central region (or inner circle region) and a smaller equivalent dielectric constant at the peripheral region (or outer circle region).

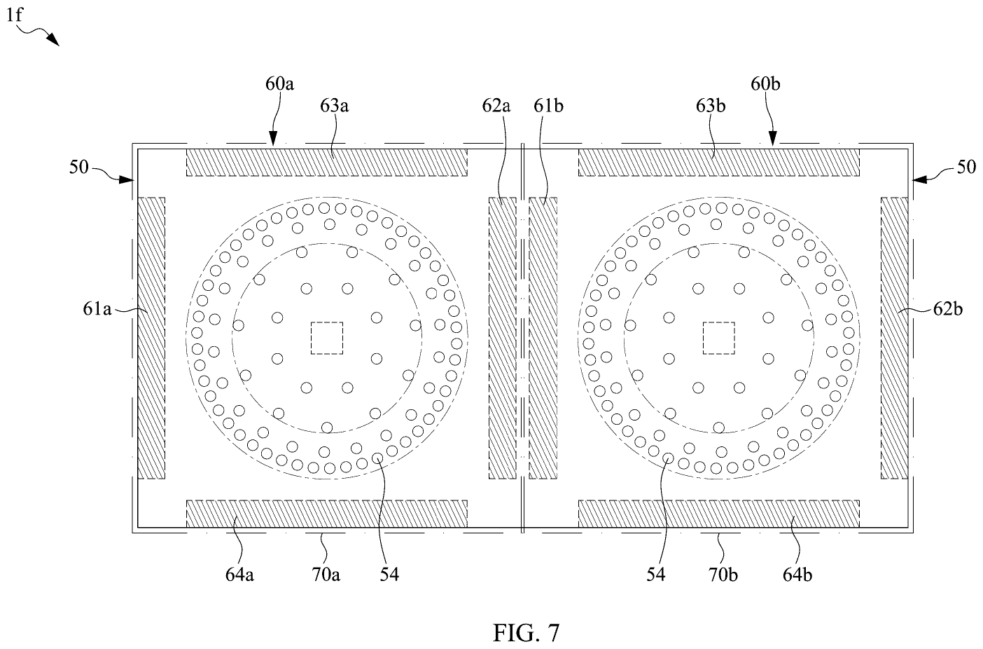

FIG. 7 is a top view of an electronic device 1f, in accordance with an embodiment of the present disclosure. The electronic device 1f is similar to the electronic device 1b, and the differences therebetween are described below.

In some embodiments, the electronic device 1f may include devices 70a and 70b. Each of the devices 70a and 70b may be one of the electronic devices 1a to 1e. The device 70a may include an antenna 60a, which includes segments 61a, 62a, 63a, and 64a. The device 70b may include an antenna 60b, which includes segment 61b, 62b, 63b, and 64b. In some embodiments, each of the antennas 60a and 60b may be free from vertically overlapping the medium 54.

In some embodiments, the dipole antenna within different devices may be coupled. For example, the segment 61a of the device 70a may be coupled to the segment 61b of the device 70b, and the segment 62a of the device 70a may be coupled to the segment 62b of the device 70b. In some embodiments, the coupled segment 61a and segment 61b may be configured to emit or receive an RF signal with a frequency different from that of the coupled segment 62a and segment 62b. For example, the segments 61a and 61b may collectively function as the first antenna array, and the segments 62a and 62b may collectively function as the second antenna array which has an operation frequency different from that of the first antenna array. Further, the segments 63a and 63b may collectively function as the third antenna array, and the segments 64a and 64b may collectively function as the fourth antenna array. In some embodiments, the signal(s) from the coupled segment 61a and segment 61b may be free of phase delays caused by the medium 54. In some embodiments, the signal(s) from the coupled segment 62a and segment 62b may be free of phase delays caused by the medium 54.

In some embodiments, an electronic device includes a directing structure and a first antenna. The directing structure includes a central region and a peripheral region. An equivalent dielectric constant of the central region is greater than that of the peripheral region. The first antenna is configured to transceive first radio-frequency (RF) signals through the directing structure.

In some embodiments, the electronic device further includes a dielectric layer disposed between the first antenna and the directing structure, wherein a dielectric constant of the directing structure is greater than that of the dielectric layer. In some embodiments, the first antenna is configured to transceive the first RF signals through the dielectric layer. In some embodiments, a thickness of the dielectric layer is less than that of the directing structure. In some embodiments, the first antenna includes a plurality of segments having an array arrangement. In some embodiments, the first antenna is partially disposed under the central region and partially under the peripheral region. In some embodiments, the directing structure comprises a first medium and a second medium within the first medium, and a density of the second medium in the central region is less than that in the peripheral region. In some embodiments, a dielectric constant of the second medium is less than that of the first medium. In some embodiments, a dimension of the second medium in the central region is less than that in the peripheral region. In some embodiments, the first medium has a substantially uniform thickness. In some embodiments, the electronic device further includes a circuit structure supporting the first antenna and a second antenna disposed between the circuit structure and the directing structure, wherein the second antenna is configured to transceive second RF signals through the directing structure. In some embodiments, the second antenna is configured to be operated at a frequency less than that of the first antenna. In some embodiments, the directing structure comprises a first medium and a second medium within the first medium with a dielectric constant less than that of the first medium, and the second antenna is free from vertically overlapping the second medium. In some embodiments, the second antenna is free from vertically overlapping the first antenna.

In some embodiments, an electronic device includes a directing structure and a first antenna. The first antenna is configured to transceive first radio-frequency (RF) signals. The directing structure is over the first antenna and includes a first medium with a density varying along a horizontal direction. The directing structure is configured to converge the first RF signals.

In some embodiments, the directing structure further includes a second medium with a dielectric constant greater than that of the first medium. In some embodiments, the second medium comprises a lens structure, and the first medium comprises air. In some embodiments, the density of the first medium decreases from a center of the second medium toward a side of the second medium. In some embodiments, the second medium is spaced apart from the first antenna. In some embodiments, a vertical distance between the first antenna and the directing structure is substantially equal to a focal length of one of the first RF signals. In some embodiments, the electronic device further includes a second antenna disposed between the first antenna and the directing structure, wherein the second antenna is configured to be operated at a frequency different from that of the first antenna. In some embodiments, a portion of the second antenna is embedded within the directing structure. In some embodiments, the second antenna is closer to a side of the directing structure than the first medium is in a top view. In some embodiments, the second antenna is closer to a side of the directing structure than the first antenna is in a top view.

In some embodiments, an electronic device includes a directing structure and a first antenna. The first antenna is configured to transceive first radio-frequency (RF) signals. The directing structure defines a plurality of through vias configured to converge the first RF signals.

In some embodiments, the directing structure has a first surface facing the first antenna and a second surface opposite to the first surface, and the second surface is a substantially flat surface. In some embodiments, a density of the plurality of through vias decreases from a center of the directing structure toward a side of the directing structure. In some embodiments, the electronic device further includes a second antenna disposed at a peripheral region of the directing structure in a top view, wherein the first antenna is operated at a first frequency and the second antenna is operated at a second frequency different from the first frequency. In some embodiments, the second antenna is free from vertically overlapping the plurality of through vias. In some embodiments, the second antenna is embedded within a dielectric layer supporting the directing structure.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated from by such an arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to #1%, less than or equal to ±0.5%, less than or equal to ±0.1%, or less than or equal to ±0.05%. For example, two numerical values can be deemed to be “substantially” the same or equal if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Two surfaces can be deemed to be coplanar or substantially coplanar if a displacement between the two surfaces is no greater than 5 μm, no greater than 2 μm, no greater than 1 μm, or no greater than 0.5 μm.

As used herein, the singular terms “a,” “an,” and “the” may include plural referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 10⁴ S/m, such as at least 10⁵ S/m or at least 10⁶ S/m. The electrical conductivity of a material can sometimes vary with temperature. Unless otherwise specified, the electrical conductivity of a material is measured at room temperature.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An electronic device, comprising:
a directing structure including a central region and a peripheral region, wherein an equivalent dielectric constant of the central region is greater than that of the peripheral region; and
a first antenna configured to transceive first radio-frequency (RF) signals through the directing structure.

2. The electronic device of claim 1, further comprising:
a dielectric layer disposed between the first antenna and the directing structure, wherein a dielectric constant of the directing structure is greater than that of the dielectric layer.

3. The electronic device of claim 2, wherein the first antenna is configured to transceive the first RF signals through the dielectric layer.

4. The electronic device of claim 2, wherein a thickness of the dielectric layer is less than that of the directing structure.

5. The electronic device of claim 1, wherein the first antenna comprises a plurality of segments having an array arrangement.

6. The electronic device of claim 1, wherein the first antenna is partially disposed under the central region and partially under the peripheral region.

7. The electronic device of claim 1, wherein the directing structure comprises a first medium and a second medium within the first medium, and a density of the second medium in the central region is less than that in the peripheral region.

8. The electronic device of claim 7, wherein a dielectric constant of the second medium is less than that of the first medium.

9. The electronic device of claim 7, wherein a dimension of the second medium in the central region is less than that in the peripheral region.

10. The electronic device of claim 7, wherein the first medium has a substantially uniform thickness.

11. An electronic device, comprising:
a first antenna configured to transceive first radio-frequency (RF) signals; and
a directing structure over the first antenna, comprising a first medium with a density varying along a horizontal direction, wherein the directing structure is configured to converge the first RF signals.

12. The electronic device of claim 11, wherein the directing structure further comprises a second medium with a dielectric constant greater than that of the first medium.

13. The electronic device of claim 12, wherein the second medium comprises a lens structure, and the first medium comprises air.

14. The electronic device of claim 12, wherein the density of the first medium decreases from a center of the second medium toward a side of the second medium.

15. The electronic device of claim 12, wherein the second medium is spaced apart from the first antenna.

16. An electronic device, comprising:
a first antenna configured to transceive first radio-frequency (RF) signals; and
a directing structure defining a plurality of through vias configured to converge the first RF signals.

17. The electronic device of claim 16, wherein the directing structure has a first surface facing the first antenna and a second surface opposite to the first surface, and the second surface is a substantially flat surface.

18. The electronic device of claim 16, wherein a density of the plurality of through vias decreases from a center of the directing structure toward a side of the directing structure.

19. The electronic device of claim 16, further comprising:
a second antenna disposed at a peripheral region of the directing structure in a top view, wherein the first antenna is operated at a first frequency and the second antenna is operated at a second frequency different from the first frequency.

20. The electronic device of claim 19, wherein the second antenna is free from vertically overlapping the plurality of through vias.
